(19) United States
(12) Patent Application Publication
(10) Pub. No.: US 2008/0168915 A1
(43) Pub. Date: Jul. 17, 2008

(54) Roller transfer printing apparatus for cold transfer printing

(75) Inventor: Po-Wen Chung, Shanghai (CN)

Correspondence Address: NATH & ASSOCIATES, 112 South West Street, Alexandria, VA, 22314, US

(73) Assignee: SHANGHAI NEWTECH FABRIC PRINTING CO., LTD., Shanghai (CN)

(21) Appl. No.: 11/798,543

(22) Filed: May 15, 2007

(30) Foreign Application Priority Data
Jan. 11, 2007 (CN) 200720066213.X

(51) Int. Cl. B41F 13/08

(52) U.S. Cl. 101/217

(57) ABSTRACT

Apparatus for cold transfer printing by means of rollers, comprising: a pair of rollers consisting of a main roller and a pressure roller, the center lines thereof being parallel with each other, the pressure roller being in close contact with the circumferential surface of the main roller, the main roller being connected with the transmission mechanism of a cold transfer printing machine, a spindle of the main roller being fixedly coupled with a frame of the machine through bearings, bearing supports and positioning and adjusting means disposed on the two ends of the spindle, and a spindle of the pressure roller being provided with bearings on the two ends thereof and connected with pressing means, with the pressure direction being directed toward the center of the main roller; and at least one auxiliary roller, situated on the side of a line joining centers of the main and pressure rollers and being in close contact with the circumferential surface of the main roller, a spindle of the auxiliary roller being provided with bearings on the two ends thereof and connected with pressing means, with the pressure direction being also directed toward the center of the main roller; wherein the main and pressure rollers have one and the same diameter, which is greater than that of the auxiliary roller; and textile and pattern paper in an engaged manner are first passed through a pre-rolling area formed between the main roller and the auxiliary roller and then through a main rolling area formed between the main roller and the pressure roller.

### TECHNICAL FIELD

The present utility model application relates to printing machinery used in textile dyeing and printing industry, in particular, a multi-roller transfer printing apparatus for cold transfer printing.

### BACKGROUND ART

Traditional transfer printing technology is limited to polyester fabric in which the dispersed dyes can be sublimated and fixed, thus sublimation transfer printing is often used in a traditional transfer printing machine, which often utilizes heat-conducting oil, superheated steam, electric heating, natural gas combustion and so on. At present, there are two main ways of transfer printing, one of which is to put the heat-conducting oil in the cavity of a main roller of a transfer printing machine, heating the heat-conducting oil with the built-in electric heating tubes in said cavity to make the surface of the main roller generate a high temperature. When the pattern-carrying paper and the textile are in closely contact with each other and passed through under the combined effects of main roller pressure and high temperature, the patterns printed on the paper by dyes are sublimated and transferred to chemical fibre textile due to the high temperature of the main roller surface. The other way consists in that the main roller uses negative pressure which makes the textile and paper adhere to the main roller, and heat is conducted to the paper and textile through an infrared reflecting plate so as to cause the dyes to be sublimated and transferred to the textile. Both transfer printing ways create a transfer printing effect on the textile and paper on the main roller by sublimation. Whereas said transfer printing ways have their own limitations, since they can not be used for cellulose fibers, protein fibers, nylon, acrylic fibres, and synthetic fibers. At present, a cold transfer printing machine can overcome said disadvantage and thus enlarge the application range of transfer printing. A cold transfer printing machine performs the pattern transferring with a normal temperature and wet method, which is carried out by pressing and wetting the color sizing used for the pattern layer for a certain period of time, due to the dissolution (in water) rate of the printing paste. This cold transfer printing method is relevant to textile type, quality of the paper, dimension of the contact surface of the main roller, nip pressure and wetting time, etc., and is more critical to the rate of transferring for color sizing and the operating speed of the transfer printing machine. In case of the same contact surface and nip pressure, the operating speed and the transferring rate are interrelated with each other. In normal condition, in order to ensure the quality of the textile pattern, it is necessary to achieve a maximum transferring rate, which is realized at a cost of slowing down the speed of the machine and prolonging wetting time so as to achieve the maximum transferring rate of color sizing and to reduce the consumption of the colour sizing. However, a cold transfer printing machine usually uses double-roller pressure transfer printing, in which the limited contact surface and the lack of time and space for dye layer's wet pealing off from the paper result in many disadvantages, such as low transferring rate, slow operating speed, poor uniformity and so on. At the same time, an extremely low operating speed of the transfer printing machine also leads to difficulty in the subsequent finishing process, and thus impairing the qualified rate of the final products and increasing the production cost.

### SUMMARY OF THE INVENTION

In order to overcome the aforesaid drawbacks, the present utility model application provides a multi-roller transfer printing apparatus intended for cold transfer printing in order to improve the transferring rate and operating speed.

Therefore, an apparatus for cold transfer printing by means of rollers is provided, comprising: a pair of rollers consisting of a main roller and a pressure roller, the center lines thereof being parallel with each other, the pressure roller being in close contact with the circumferential surface of the main roller, the main roller being connected with the transmission mechanism of a cold transfer printing machine, a spindle of the main roller being fixedly coupled with a frame of the machine through bearings, bearing supports and positioning and adjusting means disposed on the two ends of the spindle, and a spindle of the pressure roller being provided with bearings on the two ends thereof and connected with pressing means, with the pressure direction being directed toward the center of the main roller; and at least one auxiliary roller, situated on the side of a line joining centers of the main and pressure rollers and being in close contact with the circumferential surface of the main roller, a spindle of the auxiliary roller being provided with bearings on the two ends thereof and connected with pressing means, with the pressure direction being also directed toward the center of the main roller; wherein the main and pressure rollers have one and the same diameter, which is greater than that of the auxiliary roller; and textile and pattern paper in an engaged manner are first passed through a pre-rolling area formed between the main roller and the auxiliary roller and then through a main rolling area formed between the main roller and the pressure roller.

The transfer printing apparatus for cold transfer printing according to the present utility model has at least one auxiliary roller in addition to a main roller and a pressure roller so that a pre-rolling area is formed between the auxiliary roller and the main roller, and thus double wetting areas and double rolling points or three wetting areas and three rolling points are formed. The increased rolling points and the wetting contact surface for transfer printing can provide higher rate for the transfer of hydrophobic dyes, enlarge the application range of the cold transfer printing technology, and increase the operating speed of the cold transfer printing apparatus.

The advantages of the present utility model over the prior art consist in a simpler structure and a more stable operation of the apparatus during transfer printing. Thanks to the simple structure of this apparatus, the parallelism of the multiple rollers can be easily controlled and thus close contact between the printing paper and the textile is ensured. By applying pressure through the multiple rollers, the displacement between the paper and the textile during transfer printing due to their different materials or tensions is prevented, and thus the qualified rate of products is ensured. In addition, after being transfer printed by the auxiliary roller, the paper and the textile enter into the rolling area between the pressure roller and the main roller to be printed again, and thus the contact surface is enlarged, wetting of the dyes on the paper is enhanced, transfer rate is increased, consumption of the dyes is reduced, the production environment is protected and the problems of low operating speed and low transfer rate in a normal temperature cold transfer printing machine are solved.

### BRIEF DESCRIPTION OF THE DRAWINGS

FIG. 1 is a schematic view showing the structure of a three-roller transfer printing apparatus;

FIG. 2 is a schematic view showing the structure of a four-roller transfer printing apparatus;

FIG. 3 is a schematic view showing a vertical arrangement of a main roller and a pressure roller;

FIG. 4 is a schematic view showing a horizontal arrangement of a main roller and a pressure roller.

### REFERENCE NUMBERS

1—positioning and adjusting means
2—spindle
3—main roller
4—transfer printed fabric
5—transfer printed paper
6, 6—pressure roller
7—pressing means
8—spindle
9—auxiliary roller
10—spindle
11—pressing means
12—pattern paper
13—fabric.

### BEST MODE FOR CARRYING OUT THE INVENTION

The present utility model is described in detail below with reference to the accompanying drawings and embodiments.

### Embodiment 1

A three-roller transfer printing apparatus of a cold transfer printing machine.

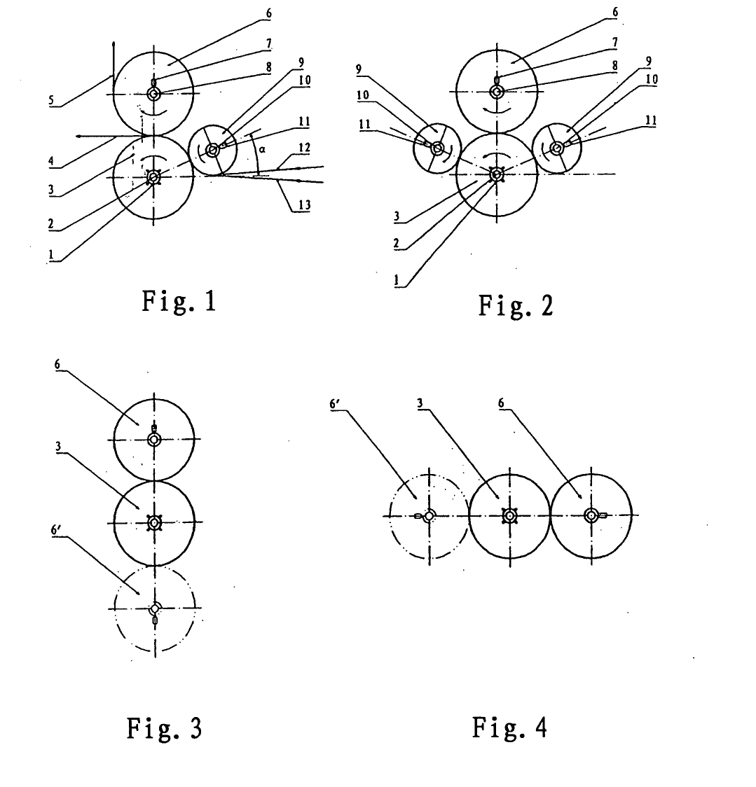

As FIG. 1 shows, a three-roller transfer printing apparatus consists of a main roller 3, a pressure roller 6, an auxiliary roller 9, a positioning and adjusting means 1, pressing means 7, 11. The main roller 3 is a bottom roller and the pressure roller 6 is in close contact with the circumferential surface of the main roller. The main roller 3 and the pressure roller 6 form a pair of rollers with their center lines being parallel, and they are tangent to each other on the circumferential surface of the main roller in a full range of 360°. The line joining the center points of the two rollers is vertical and the two rollers are vertically arranged. There is also one auxiliary roller 9 disposed on the right side of the line joining the center points of the main roller 3 and the pressure roller 6 and being in close contact with the circumferential surface of the main roller. Therefore a three-roller transfer printing apparatus is formed. The two ends of the spindle 2 of the main roller 3 are connected with the frame of the cold transfer printing machine through bearings, bearing supports and a positioning and adjusting means 1. The positioning and adjusting means 1 may be adjusted by bolts. The position of the fixed main roller 3 in a vertical direction can be adjusted through the adjustment of the positioning and adjusting means according to production requirements, whereby the nip between the main roller and the pressure roller 6 can be controlled. The two ends of the spindle 8 of the pressure roller 6 are provided with bearings, and connected by connection rods with the pneumatic pressing means 7, with the pressure direction directed toward the centre of the main roller 3. The pressure roller 6 can apply pressure to the main roller 3, and in an opposite direction, the pressure roller 6 can be lifted so as to meet the requirements of operation. The two ends of the spindle 10 of the auxiliary roller 9 are also provided with bearings and are connected through connection rods to the pneumatic pressing means 11, with the pressure direction directed toward the center of the main roller 3. Pressurizing and lifting of the auxiliary roller 9 can also be achieved. The pressure between the rollers can be adjusted both through the pressure roller 6 and through the auxiliary roller 9 according to production requirements. The main roller 3, pressure roller 6 and auxiliary roller 9 are hollow metal rollers, with the circumferential surfaces thereof cast with Buna-N rubber. The main roller 3, pressure roller 6 and auxiliary roller 9 each have a diameter of 100 mm-1800 mm and are classified into three types—light and middle type, heavy type and extremely heavy type—according to textile type, the transfer printing pattern and color, and the operating speed of the transfer printing machine, i.e. 100 mm≦the diameter of the light and middle type≦600 mm, 600 mm≦the diameter of the heavy type≦1200 mm, 1200 mm≦the diameter of the extremely heavy type≦1800 mm.

The operating principle of the three-roller transfer printing apparatus is described as follows:

After being coupled and engaged at the output portion of the cold transfer printing machine, the fabric 13 to be processed and the pattern paper 12 pass through the pre-rolling area formed between the main roller 3 and the auxiliary roller 9 so as to be in close contact with each other and wetted, and then enter into the main rolling area formed by the main roller 3 and the pressure roller 6. Due to being rolled through two passes, the transfer rate of cold transfer printing is higher than that of the prior machine with a pair of rollers, and thus the speed of the cold transfer printing machine can be made faster so that the quality of the cold transfer printing can be ensured. The transfer printed fabric 4 and paper 5 out of the main rolling area are transported to their respective areas through the conveyor of the cold transfer printing machine, and thus the operation is continuous until the processing is is finished.

In this three-roller transfer printing apparatus, the auxiliary roller 9 can be disposed on the left or right side of the line joining the center points of the main roller 3 and the pressure roller 6 according to actual requirements. The underlying principle is that after the paper and the textile have been coupled and engaged, they should first enter into the pre-rolling area formed by the main roller 3 and the auxiliary roller 9.

### Embodiment 2

Four-roller transfer printing apparatus of a cold transfer printing machine.

As FIG. 2 shows, just like Embodiment 1, a four-roller transfer printing apparatus comprises a main roller 3, a pressure roller 6, two auxiliary rollers 9, positioning and adjusting means 1, and pressing means 7 and 11. The main roller 3 is a bottom roller. The pressure roller 6 is in close contact with the circumferential surface of the main roller. The main roller 3 and the pressure roller 6 form a pair of rollers, with their center axis being parallel to each other and the joint line of the two center points being a vertical line. The two auxiliary rollers 9 are disposed respectively on the left and right side of the joint line of the center points of the main roller and the pressure roller, and in close contact with the circumferential surface of the main roller. Therefore a four-roller transfer printing apparatus is formed. The two ends of the spindle 2 of the main roller 3 are connected with the frame of the cold transfer printing machine through bearings, a bearing supports and positioning and adjusting means 1. The vertical height of the fixed main roller 3 may be adjusted by adjusting the positioning and adjusting means 1 as desired, whereby the nip between the main roller 3 and the pressure roller 6 is defined. The two ends of the spindle 8 of the pressure roller 6 are bearings which are connected to the hydraulic pressing means 8, with the pressure direction being directed toward the centre of the main roller 3. The ends of spindles 10 of the two auxiliary rollers are bearings which are connected to the hydraulic pressing means 11, with the pressure direction being directed toward the centre of the main roller 3. The pressure between these rollers can be adjusted according to production requirements. The main roller 3, pressure roller 6 and auxiliary roller 9 are hollow metal rollers, whose cavities are filled with pressure oil and whose circumferential surfaces are cast with Buna-N rubber. The main roller 3, pressure roller 6 and the two auxiliary rollers 9 each have a diameter of 100 mm-1800 mm. According to textile type, the transfer printing pattern and color and the operating speed of the transfer printing machine, the main roller 3 and pressure roller 6 have a diameter selected in a range of 600 mm-800 mm and auxiliary rollers 9 and 14 have a diameter selected in the range of 400 mm-600 mm.

In the four-roller transfer printing apparatus of this cold transfer printing machine, three pre-wetting points and three rolling points are thus formed between the main roller, pressure roller and the two auxiliary rollers respectively, and the generated transfer printing wet contact surfaces can provide maximum transfer rate for the hydrophobic dyes, and enlarge the application scope of cold transfer printing.

In the above embodiments 1 and 2, said main roller 3 is a bottom roller; the pressure roller 6 is in close contact with the circumferential surface of the main roller; the main roller 3 and the pressure roller 6 form a pair of rollers with the center lines thereof being parallel to each other, and they are tangent to each other on the circumferential surface of the main roller in a full range of 360°. Therefore the main roller 3 and pressure roller 6 may contact with the circumferential surface of the main roller over a wider range. In practice, the following four types of tangency are preferable. As FIGS. 3 and 4 show:

1. The joint line of the center points of the main roller 3 and the pressure roller 6 is a vertical line, the pressure roller 6 is disposed above the main roller 3 and is tangent to the highest point of the circumferential surface of the main roller 3. (see FIG. 3)

2. The joint line of the center points of the main roller 3 and the pressure roller 6′ is a vertical line, the pressure roller 6′ is disposed below the main roller 3 and is tangent to the lowest point of the circumferential surface of the main roller 3. (see FIG. 3)

3. The joint line of the center points of the main roller 3 and the pressure roller 6 is a horizontal line, the pressure roller 6 is disposed on the right side of the main roller 3 and is tangent to the most right point of the circumferential surface of the main roller. (see FIG. 4)

4. The joint line of the center points of the main roller 3 and the pressure roller 6′ is a horizontal line, the pressure roller 6′ is disposed on the left side of the main roller 3 and is tangent to the most left point of the circumferential surface of the main roller. (see FIG. 4)

### Embodiment 3

A vertical three-roller transfer printing apparatus.

As shown in FIG. 1, the vertical apparatus comprises a main roller 3, a pressure roller 6, an auxiliary roller 9, positioning and adjusting means 1 and pressing means 7 and 11, and its configuration is the same as that of embodiment 1.

The main roller 3 is a bottom roller. The pressure roller 6 is in close contact with the circumferential surface of the main roller. The main roller 3 and the pressure roller 6 form a pair of rollers, with their center lines being parallel to each other and the joint line of the center points thereof being a vertical line. An auxiliary roller 9 is disposed on the right side of the joint line of the center points of the main roller 3 and the pressure roller 6, and is in close contact with the circumferential surface of the main roller, wherein the angle comprised between the joint line of the center points of the auxiliary roller and the main roller and the horizontal line through the center point of the main roller is in a range of 0°-45°. The following two kinds of three-roller transfer printing apparatus are the most preferable, i.e. the main roller and the pressure roller each have a diameter of 1000 mm, and the auxiliary roller has a diameter of 700 mm; or the main roller and the pressure roller each have a diameter of 600 mm, and the auxiliary roller has a diameter of 400 mm. They are respectively adapted to light and middle type and heavy type cold transfer printing machines.

What is claimed is that:

1. Apparatus for cold transfer printing by means of rollers, comprising:
a pair of rollers consisting of a main roller and a pressure roller, the center lines thereof being parallel with each other, the pressure roller being in close contact with the circumferential surface of the main roller, the main roller being connected with the transmission mechanism of a cold transfer printing machine, a spindle of the main roller being fixedly coupled with a frame of the machine through bearings, bearing supports and positioning and adjusting means disposed on the two ends of the spindle, and a spindle of the pressure roller being provided with bearings on the two ends thereof and connected with pressing means, with the pressure direction being directed toward the center of the main roller; and
at least one auxiliary roller, situated on the side of a line joining centers of the main and pressure rollers and being in close contact with the circumferential surface of the main roller, a spindle of the auxiliary roller being provided with bearings on the two ends thereof and connected with pressing means, with the pressure direction being also directed toward the center of the main roller;
wherein the main and pressure rollers have one and the same diameter, which is greater than that of the auxiliary roller; and textile and pattern paper in an engaged manner are first passed through a pre-rolling area formed between the main roller and the auxiliary roller and then through a main rolling area formed between the main roller and the pressure roller.

2. The apparatus of claim 1, wherein the main roller, the pressure roller and the auxiliary roller have their diameters between 100 mm and 1800 mm.

3. The apparatus of claim 1, wherein the main roller and pressure roller both have a diameter of 1000 mm, and the auxiliary roller has a diameter of 700 mm.

4. The apparatus of claim 1, wherein the main roller and pressure roller both have a diameter of 600 mm, and the auxiliary roller has a diameter of 400 mm.

5. The apparatus of any of claims 1-4, wherein the main roller, the pressure roller and the auxiliary roller are all hollow metal rollers, with the circumferential surfaces thereof cast with rubber and the cavities thereof filled with pressure oil.

6. The apparatus of claim 5, wherein the main roller and the pressure roller are horizontally arranged.

7. The apparatus of claim 5, wherein the main roller and the pressure roller are vertically arranged.

8. The apparatus of claim 6, wherein the main roller is below the pressure roller, and there is provided with one auxiliary roller, and the angle included between a line, which joins the centers of the main roller and auxiliary roller together, and the horizontal plane is in the range of 0-45°.
